(19) United States
(12) Patent Application Publication
(10) Pub. No.: US 2003/0022687 A1
(43) Pub. Date: Jan. 30, 2003

(54) Radio communication apparatus

(76) Inventors: Mikiya Iida, Hino-shi (JP); Hideki Aisaka, Hino-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/200,163

(22) Filed: Jul. 23, 2002

(30) Foreign Application Priority Data
Jul. 25, 2001 (JP) 2001-224597

(51) Int. Cl. H04B 7/00

(52) U.S. Cl. 455/522; 455/69

(57) ABSTRACT

A power amplifier amplifies the power of a transmission signal and outputs the amplified signal to an antenna. A power detector detects the power of the amplified signal. A first comparator compares the detected power with a first reference signal. A power adjuster adjusts the power of the transmission signal to a desired power value on the basis of the comparison result of the first comparator. A second comparator compares the detected power with a second reference signal. A controller controls the supply of power to the power amplifier or the power adjuster on the basis of the comparison result of the second comparator.

### CROSS-REFERENCE TO RELATED APPLICATIONS

This application is based upon and claims the benefit of priority from the prior Japanese Patent Application No. 2001-224597, filed Jul. 25, 2001, the entire contents of which are incorporated by reference.

### BACKGROUND OF THE INVENTION

1. Field of the Invention

The present invention relates to a radio communication apparatus having a circuit for controlling transmission power, and more particularly to a radio communication apparatus having a control circuit for adjusting transmission power to a desired value.

2. Description of the Related Art

In a conventional radio communication apparatus having a circuit for controlling transmission power, a comparator 30 compares the output of a detection circuit 29 with a first reference signal (reference 1) as shown in FIG. 1. Depending upon whether or not the output voltage of the detection circuit 29 is higher than the voltage of the first reference signal, the output signal of the comparator 30 varies. A change in the output signal is fed back to a variable gain amplifier 23 or variable attenuator.

If the output voltage of the detection circuit 29 is higher than the voltage of the first reference signal, the comparator 30 outputs a signal for reducing the power of a transmission signal. The output signal is supplied to the variable gain amplifier 23, where the output signal is controlled so that the gain of the transmission signal will be a negative value. As a result, the power of the transmission signal is reduced.

On the other hand, if the output voltage of the detection circuit 29 is not higher than the voltage of the first reference signal, the comparator 30 outputs a signal for increasing the power of a transmission signal. The output signal is supplied to the variable gain amplifier 23, where the output signal is controlled so that the gain of the transmission signal will be a positive value. As a result, the power of the transmission signal is increased.

The above-described feedback control is executed to enable signal transmission with power having an almost desired range.

However, if a problem occurs in the detection circuit 29 and hence the circuit 29 outputs a signal of a level lower than a desired voltage level, the gain of the variable gain amplifier 23 is adjusted to a higher value. As a result, signal transmission may be executed with power higher than desired power.

If the communication mode is, for example, CDMA (Code Division Multiple Access), communications are executed using a common channel between a single base station and a plurality of radio communication apparatuses. Further, the total power of the electric waves the base station can treat is substantially constant. Therefore, if signal transmission is executed with high power between the base station and a certain radio communication apparatus as stated above, the high-power signal will undesirably be a radio-frequency interference signal to communications between other radio communication apparatuses and the base station. In this case, it is very possible that some radio communication apparatuses may be disconnected from the base station.

Further, if the communication mode is TDMA (Time Division Multiple Access), the transmission power used in a transmission circuit is substantially constant as compared to CDMA. Accordingly, once a transmission circuit has consumed much power, the transmission circuit continues to consume much power. As a result, a radio communication apparatus incorporating the transmission circuit significantly consumes power and hence the battery of the apparatus may soon run out.

### BRIEF SUMMARY OF THE INVENTION

It is an object of the invention to provide a radio communication apparatus that inhibits the transmission operation of the apparatus if the radio communication apparatus detects a problem in the detection circuit of the apparatus.

According to a first aspect of the invention, there is provided a radio communication apparatus comprising:

a power amplifier configured to amplify power of a transmission signal and output the amplified signal to an antenna;

a power detector configured to detect power of the amplified signal;

a first comparator configured to compare the detected power with a first reference signal;

a power adjuster configured to adjust the power of the transmission signal to a desired power value on the basis of a comparison result of the first comparator;

a second comparator configured to compare the detected power with a second reference signal; and

a controller configured to control supply of power to the power amplifier on the basis of a comparison result of the second comparator.

According to a second aspect of the invention, there is provided a radio communication apparatus comprising:

a power amplifier configured to amplify power of a transmission signal and output the amplified signal to an antenna;

a power detector configured to detect power of the amplified signal;

a first comparator configured to compare the detected power with a first reference signal;

a power adjuster configured to adjust the power of the transmission signal to a desired power value on the basis of a comparison result of the first comparator;

a second comparator configured to compare the detected power with a second reference signal; and

a controller configured to control supply of power to the power adjuster on the basis of a comparison result of the second comparator.

According to a third aspect of the invention, there is provided a radio communication apparatus comprising:

a power amplifier configured to amplify power of a transmission signal and output the amplified signal to an antenna;

a power detector configured to detect power of the amplified signal;

a first comparator configured to compare the detected power with a first reference signal;

a power adjuster configured to adjust the power of the transmission signal to a desired power value on the basis of a comparison result of the first comparator;

a second comparator configured to compare the detected power with a second reference signal; and

an inhibiting part configured to inhibit supply of the amplified signal to the antenna on the basis of a comparison result of the second comparator.

According to a fourth aspect of the invention, there is provided a radio communication apparatus comprising:

a first frequency generator configured to generate a frequency signal having a first preset frequency;

a modulator configured to modulate a baseband signal on the basis of the frequency signal generated by the first frequency generator;

a power adjuster configured to adjust the modulated baseband signal to a desired power value;

a second frequency generator configured to generate a frequency signal having a second preset frequency;

a frequency converter configured to convert a frequency of the adjusted baseband signal on the basis of the frequency signal generated by the second frequency generator;

a power amplifier configured to amplify power of the converted signal;

a power detector configured to detect power of the amplified signal;

a first comparator configured to compare the detected power with a first reference signal and output a compared result to the power adjuster;

a second comparator configured to compare the detected power with a second reference signal; and

an inhibiting part configured to inhibit supply of power to at least one of the first and second frequency generators, the modulator, the power adjuster, the frequency converter and the power amplifier, if the second comparator determines that the detected power is lower than the second reference signal.

According to a fifth aspect of the invention, there is provided a radio communication apparatus comprising:

a first frequency generator configured to generate a frequency signal having a first preset frequency;

a modulator configured to modulate a baseband signal on the basis of the frequency signal generated by the first frequency generator;

a power adjuster configured to adjust the modulated baseband signal to a desired power value;

a second frequency generator configured to generate a frequency signal having a second preset frequency;

a frequency converter configured to convert a frequency of the adjusted baseband signal on the basis of the frequency signal generated by the second frequency generator;

a power amplifier configured to amplify power of the converted signal;

a power detector configured to detect power of the amplified signal;

a first comparator configured to compare the detected power with a first reference signal and output a compared result to the power adjuster;

a second comparator configured to compare the detected power with a second reference signal; and

an inhibiting part configured to inhibit supply of power to all of the first and second frequency generators, the modulator, the power adjuster, the frequency converter and the power amplifier, if the second comparator determines that the detected power is lower than the second reference signal.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram illustrating the electrical structure of a transmission power control circuit incorporated in a conventional radio unit;

FIG. 2 is a block diagram illustrating the entire configuration of a radio communication apparatus, according to the embodiment of the invention, which comprises a radio unit including a transmission power control circuit and a control section;

FIG. 3 is a block diagram of a radio communication apparatus according to a first embodiment of the invention, illustrating the electrical configuration of a transmission power control circuit, and electrical connection between the transmission power control circuit and a control section that outputs a control signal for turning on/off predetermined elements incorporated in the transmission power control circuit;

FIG. 4 is a graph indicating the relationship between the output voltage of a power amplifier and the output voltage of a detection circuit, assumed that the detection circuit is normal; and

FIG. 5 is a block diagram of a radio communication apparatus according to a second embodiment of the invention, illustrating the electrical configuration of a transmission power control circuit, and electrical connection between the transmission power control circuit and a control section that outputs a control signal for turning on/off predetermined elements incorporated in the transmission power control circuit.

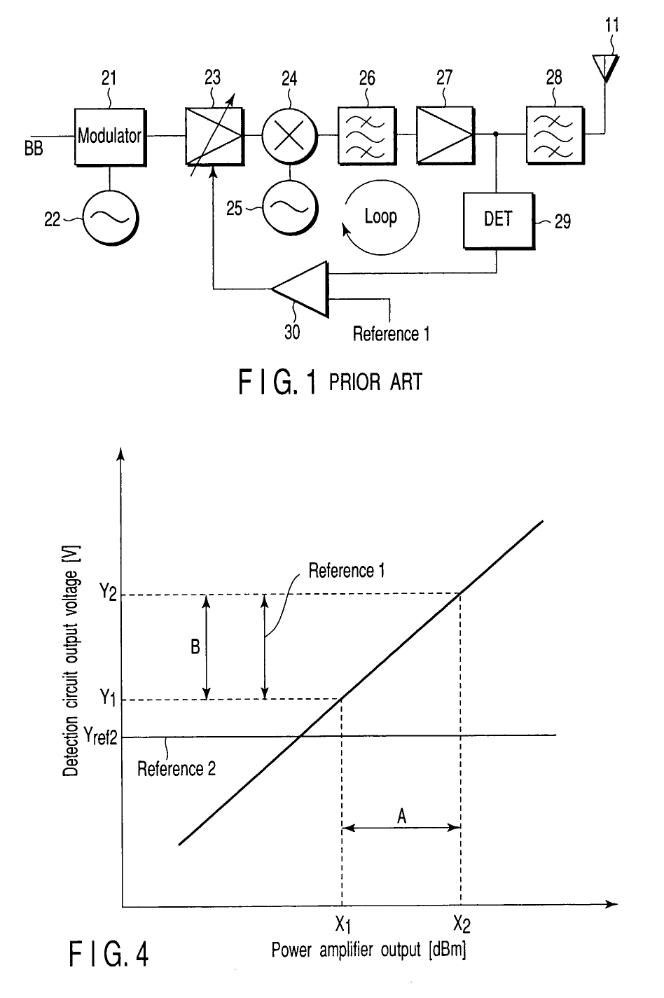

### DETAILED DESCRIPTION OF THE INVENTION

A radio communication apparatus according to embodiments of the invention will be described with reference to the accompanying drawings.

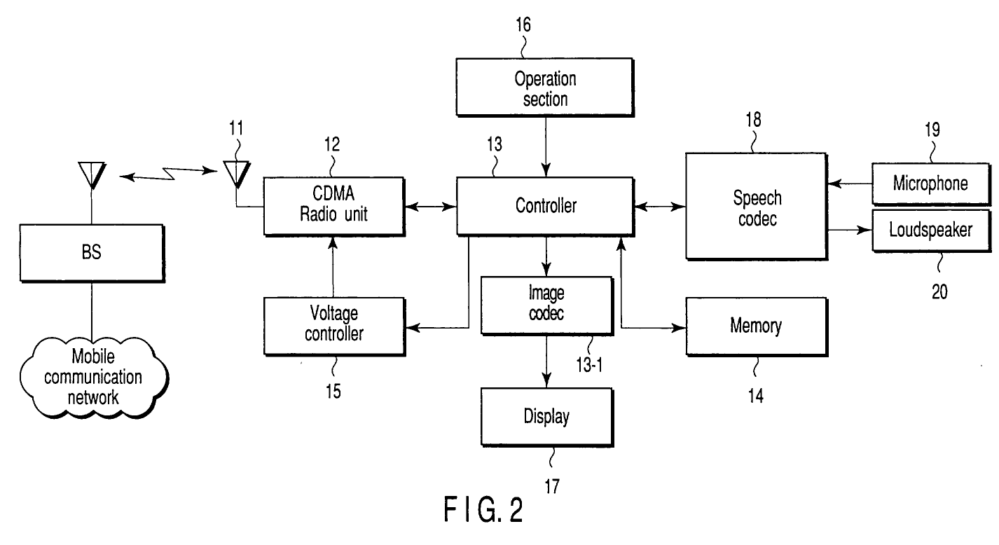

FIG. 2 is a block diagram illustrating the electrical structure of a radio communication apparatus, according to the embodiment of the invention, which comprises a radio unit including a transmission power control circuit and a control section.

The radio communication apparatus has a CDMA radio communication function. In the CDMA mode, communications are executed with the radio communication apparatus synchronized with a base station connected to a public network. Further, a radio unit 12 incorporated in the apparatus employs, for example, QPSK (Quadrature Phase Shift Keying) as the modulation mode.

A voltage controller 15 controls the gain of an amplifier incorporated in the CDMA radio unit 12 under the control of a control section 13. As a result of this control, the transmission level of a CDMA signal to be transmitted to the base station is determined.

A speech codec 18 encodes a transmission speech signal input from a microphone 19 in accordance with a predetermined speech encoding mode and decodes a signal input via the CDMA radio unit 12 and control section 13 into a received signal. The received signal is output through a loudspeaker 20.

An image codec 13-1 decodes received image data or image data stored in a memory 14. The resultant image is displayed on a display 17 such as an LCD (Liquid Crystal Display).

An operation section 16 is a key input section that includes a ten-key pad, a four-direction-key pad and various function keys, etc. The operation section 16 is used for, for example, the scroll of information displayed on the display 17 as well as usual signal reception/transmission or instructions to a destination apparatus.

The memory 14 is formed of a semiconductor memory such as a RAM (Random Access Memory) or a ROM (Read Only Memory). The memory 14 stores data to be transmitted using CDMA, received data, menu information formed of some of the data, etc.

The control section 13 controls each section of the radio communication apparatus. Specifically, the control section 13 executes various types of control related to CDMA radio communications or to exchange of information such as a phone directory, mails, schedules, etc.

The present invention is applicable not only to CDMA but also to TDMA. CDMA and TDMA circuit structures differ in the modulation or demodulation form. Accordingly, in the case of using TDMA, the CDMA radio unit 12 is modified so that the modified radio unit will be compatible with TDMA.

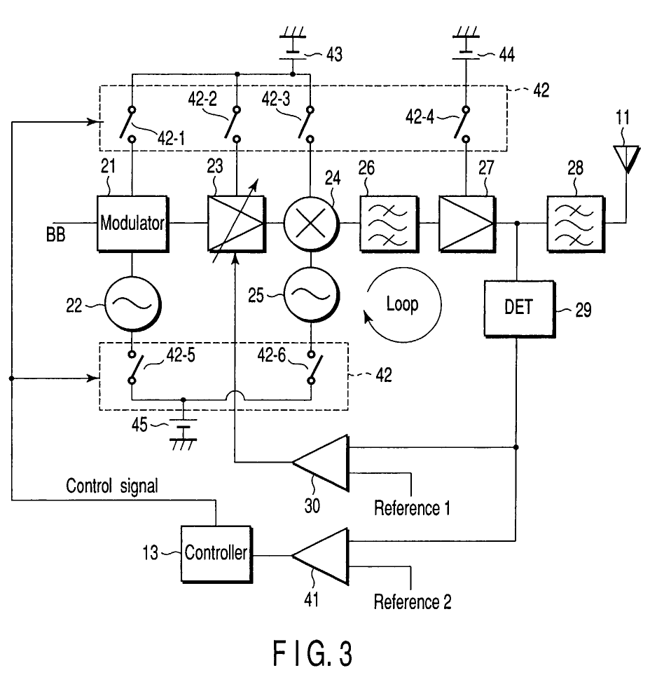

FIG. 3 is a block diagram of a radio communication apparatus according to a first embodiment of the invention, illustrating the electrical configuration of a transmission power control circuit, and electrical connection between the transmission power control circuit and a control section that outputs a control signal for turning on/off predetermined elements incorporated in the transmission power control circuit.

A baseband signal, converted into an analog signal and output from the control section 13, is input to a modulator 21. The modulator 21 modulates the baseband signal on the basis of a frequency signal output from a local frequency signal generator 22.

The modulated baseband signal is input to a variable gain amplifier 23, where the modulated baseband signal is amplified to a desired power value. The amplified signal is input to a frequency converter 24. The frequency converter 24 converts the frequency of the amplified signal on the basis of a frequency signal output from a local frequency signal generator 25.

The frequency-converted signal is input to a band-pass filter 26, where a noise component or an undesired signal component which is not within a transmission band is attenuated. The signal having an undesired component attenuated is input to a power amplifier 27, where the attenuated signal is amplified to desired transmission power.

The thus-amplified signal is output to an antenna 11 via a duplexer 28, where the amplified signal is transmitted.

Further, the amplified signal as the output of the power amplifier 27 is converted into a direct-current voltage signal by a detection circuit 29. The detection circuit 29 is provided for detecting the power of the signal output from the power amplifier 27. The direct-current voltage signal converted by the detection circuit is input to a first comparator 30 and a second comparator 41.

The first comparator 30 compares the output voltage of the detection circuit 29 with the voltage of a first reference signal (reference 1). A comparator similar to the first comparator 30 is employed in a conventional transmission power control circuit.

The first reference signal is a direct-current voltage signal having a threshold voltage for determining the output voltage of the first comparator 30, and is used to determine the power of a transmission signal.

Specifically, if the output voltage of the detection circuit 29 is higher than the voltage of the first reference signal, the first comparator 30 supplies the variable gain amplifier 23 with a signal for setting the gain of the variable gain amplifier 23 to a negative value. On the other hand, if the output voltage of the detection circuit 29 is not higher than the voltage of the first reference signal, the first comparator 30 supplies the variable gain amplifier 23 with a signal for setting the gain of the variable gain amplifier 23 to a positive value.

In other words, the power value of a transmission signal is fed back to control the gain of the variable gain amplifier 23 on the basis of the power value of the transmission signal. As a result, the transmission signal can be transmitted from the antenna 11 with a desired transmission power value corresponding to the first reference signal.

The second comparator 41 compares the output voltage of the detection circuit 29 with the voltage of a second reference signal (reference 2). The second reference signal is a direct-current voltage signal having a threshold voltage value for determining the output voltage of the second comparator 41 and is used to inhibit the supply of power to the transmission power control circuit so as to prevent a transmission signal from being transmitted via the antenna 11.

Specifically, if the output voltage of the detection circuit 29 is not higher than the voltage of the second reference signal, the second comparator 41 supplies the control section 13 with a signal for inhibiting the supply of power to the transmission power control circuit. On the other hand, if the output voltage of the detection circuit 29 is higher than the voltage of the second reference signal, the second comparator 41 supplies the control section 13 with a signal for continuing the supply of power to the transmission power control circuit.

Alternatively, if the output voltage of the detection circuit 29 is higher than the voltage of the second reference signal, the supply of power to the transmission power control circuit may be continued without supplying any signal to the control section 13. Control is executed so that power is continuously supplied to the transmission power control circuit.

If the output signal of the detection circuit 29 has an extremely low voltage, it is determined that the detection circuit 29 is in an abnormal state, whereby the supply of power to the transmission power control circuit is inhibited on the basis of the output signal of the second comparator 41.

Further, a switching circuit 42 for turning on/off a transmission power control signal output from the control section 13 is provided. The switching circuit 42 includes switches 42-1, 42-1, 42-3, 42-4, 42-5 and 42-6 for turning on/off the supply of power to the modulator 21, variable gain amplifier 23, frequency converter 24, power amplifier 27 and local frequency signal generators 22 and 25.

The switches 42-1, 42-1 and 42-3 are connected to a power supply 43. The switch 42-4 is connected to a power supply 44. The switches 42-5 and 42-6 are connected to a power supply 45. These switches are used to supply power to the respective elements and to interrupt the supply of power thereto.

To inhibit the power supply to the transmission power control circuit, the control section 13 controls the switching circuit 42. Specifically, when the second comparator 41 has detected an abnormality in the detection circuit 29 as aforementioned, the control section 13 turns off at least one of the switches 42-1, 42-1, 42-3, 42-4, 42-5 and 42-6, with the result that the supply of power to the power amplifier 27 is inhibited, thereby inhibiting the transmission operation of the radio communication apparatus and hence inhibiting the transmission of a signal therefrom. In this case, it is advantageous in light of power saving to turn off the switch 42-4, since the power consumption of the switch 42-4 is maximum between the switches.

Moreover, to reduce the consumption of power to the maximum degree, all the switches 42-1, 42-2, 42-3, 42-4, 42-5 and 42-6 are turned off. In this case, all the power to be supplied by the power supplies 43, 44 and 45 is saved, and at the same time, the transmission operation of the radio communication apparatus is inhibited.

Before shipping the product the maker may set which one of the switches should be turned off, or after shipping of the product the service company may set which one of the switches should be turned off.

If the switches or a switch of the switching circuit 42 is turned off, and no transmission signal is generated by the ratio communication apparatus, a message indicative of this is displayed on the display 17.

More specifically, when the control section 13 has received a signal output from the second comparator 41 if the output voltage of the detection circuit 29 is not higher than the voltage of the second reference signal, a message stating, for example, that “Please repair the detection circuit” is displayed on the display 17. Instead of the message, a mark indicative of the failure of the detection circuit 29 may be displayed. The maker can determine the failure of the detection circuit 29 from the mark.

As described above, in this embodiment, when a problem has occurred in the detection circuit 29, the output voltage of the detection circuit 29 is compared with the voltage of the second reference signal used for inhibiting the transmission power. In the prior art, if the output voltage of the detection circuit is low, the transmission signal is transmitted with high power as a result of feedback control. In light of this, in the first embodiment, the second reference signal is used to inhibit the signal transmission in such a case. As described above, the radio communication apparatus according to the first embodiment can detect a problem in the detection circuit 29, thereby inhibiting its transmission operation.

FIG. 4 shows the relationship between the output voltage of a power amplifier and the output voltage of a detection circuit, assumed that the detection circuit is normal.

If the detection circuit is normal, the output voltage of the power amplifier 27 varies within the range A of from X₁ to X₂ shown in FIG. 4. The output range A results from the feature of CDMA that the transmission power of the radio communication apparatus is varied on the basis of the power of a signal received by the apparatus or an instruction signal output from the base station.

Furthermore, the transmission power determined from the gain of the power amplifier 27 is adjusted to a desired value by feedback control using the first reference signal. The voltage of the first reference signal is varied on the basis of the power of a received signal or instruction signal from the base station.

Specifically, if the detection circuit 29 is normal, the voltage of the first reference signal varies within the range B of from Y₁ to Y₂ shown in FIG. 4.

If, on the other hand, the detection circuit 29 is abnormal, the slope of the straight line in FIG. 4, for example, is small. In this case, even if the output voltage of the power amplifier 27 varies within the range of from X₁ to X₂, there is a case where the output voltage of the detection circuit 29 is lower than Y₁.

Further, the output voltage of the detection circuit 29 also varies in accordance with the voltage of the first reference signal as a result of feedback control. Therefore, the output voltage of the detection circuit 29 also varies within the range B of from Y₁ to Y₂, shown in FIG. 4, in accordance with the output voltage of the amplifier varying within the range of from X₁ to X₂.

Since the voltage of the second reference signal is a reference voltage used for detecting whether the output voltage of the detection circuit 29 is lower than a desired value, the voltage of the second reference signal is set to a value lower than Y₁ shown in FIG. 4, for example, to a value Y_{ref2} that is the intersection of the reference 2 and the ordinate in FIG. 4. In other words, the voltage of the second reference signal is set to a value lower than the voltage of the first reference signal.

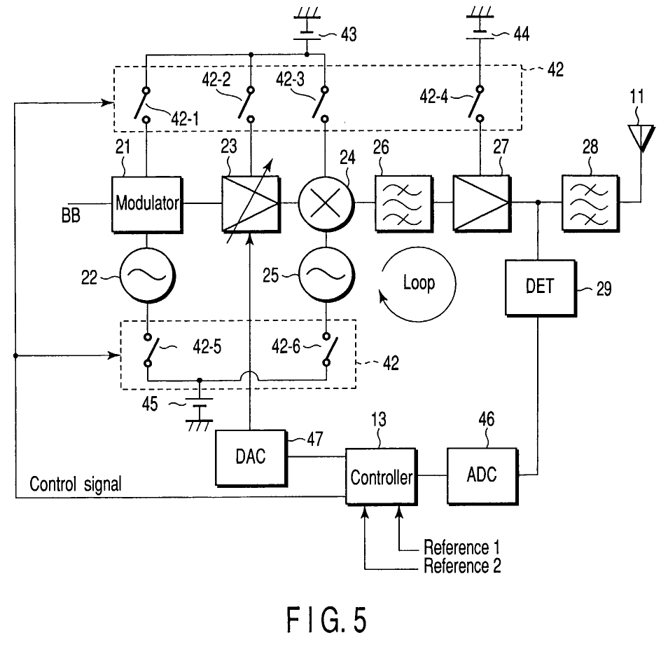

FIG. 5 is a block diagram of a radio communication apparatus according to a second embodiment of the invention, illustrating the electrical configuration of a transmission power control circuit, and electrical connection between the transmission power control circuit and a control section that outputs a control signal for turning on/off predetermined elements incorporated in the transmission power control circuit.

A baseband signal, converted into an analog signal and output from the control section 13, is input to a modulator 21. The modulator 21 modulates the baseband signal on the basis of a frequency signal output from a local frequency signal generator 22.

The modulated baseband signal is input to a variable gain amplifier 23, where the modulated baseband signal is amplified to a desired power value. As in the first embodiment, the amplified signal is transmitted from an antenna 11 via a frequency converter 24, band-pass filter 26, power amplifier 27 and duplexer 28.

In the second embodiment, an analog-to-digital converter 46 and digital-to-analog converter 47 are used in place of the comparators 30 and 41 as employed in the first embodiment. The output signal of the detection circuit 29 is converted into a digital signal by the analog-to-digital converter 46, and is output to a control section 13.

The control section 13 receives a first reference signal as a digital signal for determining the power of a transmission signal and a second reference signal as a digital signal for inhibiting the supply of power to the transmission power control circuit to thereby prevent a transmission signal from being transmitted from the antenna 11. The control executed using the first and second reference signals is similar to that in the first embodiment.

The first reference signal is referred to in order to feed back the power of a transmission signal and control the gain of the variable gain amplifier 23 on the basis of the power of the transmission signal. Specifically, a digital signal indicative of the output voltage of the detection circuit 29 is compared with the first reference signal (reference 1).

If the output voltage of the detection circuit 29, indicated by the digital signal, is higher than the voltage of the first reference signal, the control section 13 supplies, via the digital-to-analog converter 47, the variable gain amplifier 23 with a signal for setting the gain of the variable gain amplifier 23 to a negative value. On the other hand, if the output voltage of the detection circuit 29, indicated by the digital signal, is not higher than the voltage of the first reference signal, the control section 13 supplies, via the digital-to-analog converter 47, supplies the variable gain amplifier 23 with a signal for setting the gain of the variable gain amplifier 23 to a positive value.

The control section 13 calculates the gain of the variable gain amplifier 23 so that the transmission power will correspond to the first reference signal, thereby supplying a signal for controlling the gain to the digital-to-analog converter 47. As a result, a signal can be transmitted from the antenna 11 with desired transmission power corresponding to the first reference signal.

The second reference signal is used to inhibit the supply of power to the transmission power control circuit if the digitally converted output signal of the detection circuit 29 is abnormally low and the detection circuit 29 is determined abnormal.

Specifically, if the voltage indicated by the digitally converted output signal of the detection circuit 29 is not higher than the voltage indicated by the second reference signal, the control section 13 outputs a signal for inhibiting the supply of power to the transmission power control circuit. On the other hand, if the voltage indicated by the digitally converted output signal of the detection circuit 29 is higher than the voltage indicated by the second reference signal, the control section 13 outputs a signal for continuing the supply of power to the transmission power control circuit.

Alternatively, if the voltage indicated by the digitally converted output signal of the detection circuit 29 is higher than the voltage indicated by the second reference signal, the supply of power to the transmission power control circuit may be continued without outputting any signal from the control section 13.

Further, the second embodiment also employs a switching circuit 42 for turning on/off a transmission power control signal output from the control section 13. This switching circuit is similar to the circuit of the first embodiment in the configuration and control method of the switching circuit.

If the switches of the switch circuit 42 are turned off, and no transmission signal is generated by the radio communication apparatus, a message indicating that no transmission signal is generated is displayed on the display 17 as in the first embodiment.

As described above, in the second embodiment, the first and second reference signals input to the control section 13 are not analog signals having respective voltages as shown in FIG. 4 but digital signals indicative of the voltages.

However, if the first and second reference signals are digitally converted by an analog-to-digital converter before the first and second reference signals are input to the control section 13, the same type first and second reference signals may be used in the first and second embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication apparatus comprising:
a power amplifier configured to amplify power of a transmission signal and output the amplified signal to an antenna;
a power detector configured to detect power of the amplified signal;
a first comparator configured to compare the detected power with a first reference signal;
a power adjuster configured to adjust the power of the transmission signal to a desired power value on the basis of a comparison result of the first comparator;
a second comparator configured to compare the detected power with a second reference signal; and
a controller configured to control supply of power to the power amplifier on the basis of a comparison result of the second comparator.

2. The radio communication apparatus according to claim 1, wherein the second comparator operates the controller if a voltage indicated by a signal output from the power detector is lower than a voltage indicated by the second reference signal.

3. A radio communication apparatus comprising:
a power amplifier configured to amplify power of a transmission signal and output the amplified signal to an antenna;
a power detector configured to detect power of the amplified signal;
a first comparator configured to compare the detected power with a first reference signal;
a power adjuster configured to adjust the power of the transmission signal to a desired power value on the basis of a comparison result of the first comparator;
a second comparator configured to compare the detected power with a second reference signal; and
a controller configured to control supply of power to the power adjuster on the basis of a comparison result of the second comparator.

4. The radio communication apparatus according to claim 3, wherein the second comparator operates the controller if a voltage indicated by a signal output from the power detector is lower than a voltage indicated by the second reference signal.

5. A radio communication apparatus comprising:
a power amplifier configured to amplify power of a transmission signal and output the amplified signal to an antenna;
a power detector configured to detect power of the amplified signal;
a first comparator configured to compare the detected power with a first reference signal;
a power adjuster configured to adjust the power of the transmission signal to a desired power value on the basis of a comparison result of the first comparator;
a second comparator configured to compare the detected power with a second reference signal; and
an inhibiting part configured to inhibit supply of the amplified signal to the antenna on the basis of a comparison result of the second comparator.

6. The radio communication apparatus according to claim 5, wherein if a voltage indicated by a signal output from the power detector is lower than a voltage indicated by the second reference signal, the second comparator outputs a signal for informing a user that the power detector is out of order.

7. The radio communication apparatus according to claim 5, wherein the second reference signal indicates a constant voltage which is lower than a voltage indicated by the first reference signal.

8. The radio communication apparatus according to claim 5, wherein if a voltage indicated by a signal output from the power detector is lower than a voltage indicated by the second reference signal, the second comparator operates the inhibiting part.

9. The radio communication apparatus according to claim 8, wherein the second comparator converts the output signal from the power detector into a digital signal and compares a voltage indicated by the converted signal with the voltage indicated by the second reference signal.

10. The radio communication apparatus according to claim 5, wherein the first comparator supplies the power adjuster with a reducing signal for reducing the power of the transmission signal, if a voltage indicated by a signal output from the power detector is higher than a voltage indicated by the first reference signal; and
the first comparator supplies the power adjuster with an increasing signal for increasing the power of the transmission signal, if the voltage indicated by the signal output from the power detector is not higher than the voltage indicated by the first reference signal.

11. The radio communication apparatus according to claim 10, wherein the first comparator converts the output signal from the power detector into a digital signal and compares a voltage indicated by the converted signal with the voltage indicated by the first reference signal.

12. A radio communication apparatus comprising:
a first frequency generator configured to generate a frequency signal having a first preset frequency;
a modulator configured to modulate a baseband signal on the basis of the frequency signal generated by the first frequency generator;
a power adjuster configured to adjust the modulated baseband signal to a desired power value;
a second frequency generator configured to generate a frequency signal having a second preset frequency;
a frequency converter configured to convert a frequency of the adjusted baseband signal on the basis of the frequency signal generated by the second frequency generator;
a power amplifier configured to amplify power of the converted signal;
a power detector configured to detect power of the amplified signal;
a first comparator configured to compare the detected power with a first reference signal and output a compared result to the power adjuster;
a second comparator configured to compare the detected power with a second reference signal; and
an inhibiting part configured to inhibit supply of power to at least one of the first and second frequency generators, the modulator, the power adjuster, the frequency converter and the power amplifier, if the second comparator determines that the detected power is lower than the second reference signal.

13. The radio communication apparatus according to claim 12, wherein if a voltage indicated by a signal output from the power detector is lower than a voltage indicated by the second reference signal, the second comparator outputs a signal for informing a user that the power detector is out of order.

14. The radio communication apparatus according to claim 12, wherein the second reference signal indicates a constant voltage which is lower than a voltage indicated by the first reference signal.

15. The radio communication apparatus according to claim 12, wherein if a voltage indicated by a signal output from the power detector is lower than a voltage indicated by the second reference signal, the second comparator operates the inhibiting part.

16. The radio communication apparatus according to claim 15, wherein the second comparator converts the output signal from the power detector into a digital signal and compares a voltage indicated by the converted signal with the voltage indicated by the second reference signal.

17. The radio communication apparatus according to claim 12, wherein the first comparator supplies the power adjuster with a reducing signal for reducing power of a transmission signal, if a voltage indicated by a signal output from the power detector is higher than a voltage indicated by the first reference signal; and
the first comparator supplies the power adjuster with an increasing signal for increasing power of a transmission signal, if the voltage indicated by the signal output from the power detector is not higher than the voltage indicated by the first reference signal.

18. The radio communication apparatus according to claim 17, wherein the first comparator converts the output signal from the power detector into a digital signal and compares a voltage indicated by the converted signal with the voltage indicated by the first reference signal.

19. A radio communication apparatus comprising:
a first frequency generator configured to generate a frequency signal having a first preset frequency;
a modulator configured to modulate a baseband signal on the basis of the frequency signal generated by the first frequency generator;
a power adjuster configured to adjust the modulated baseband signal to a desired power value;
a second frequency generator configured to generate a frequency signal having a second preset frequency;
a frequency converter configured to convert a frequency of the adjusted baseband signal on the basis of the frequency signal generated by the second frequency generator;
a power amplifier configured to amplify power of the converted signal;
a power detector configured to detect power of the amplified signal;
a first comparator configured to compare the detected power with a first reference signal and output a compared result to the power adjuster;
a second comparator configured to compare the detected power with a second reference signal; and
an inhibiting part configured to inhibit supply of power to all of the first and second frequency generators, the modulator, the power adjuster, the frequency converter and the power amplifier, if the second comparator determines that the detected power is lower than the second reference signal.
